(19) United States
(12) Patent Application Publication
(10) Pub. No.: US 2004/0217215 A1
(43) Pub. Date: Nov. 4, 2004

(54) Method and apparatus for spray nozzle improvement through the use of surface and sub-surface coatings

(76) Inventor: Michael S. McLaughlin, Hudson Falls, NY (US)

Correspondence Address: FROMMER LAWRENCE & HAUG, 745 FIFTH AVENUE- 10TH FL., NEW YORK, NY, 10151, US

(21) Appl. No.: 10/408,700

(22) Filed: Apr. 7, 2003

(51) Int. Cl. B05B 1/00

(52) U.S. Cl. 239/589

(57) ABSTRACT

A method of forming and a spray nozzle for the application of liquids, powders and gasses, formed of a nozzle, an inlet orifice, an outlet orifice, a lumen connecting the inlet and outlet orifices, and a plating impregnated with a lubricious material. The plating is impregnated with a lubricious material to prevent corrosion and build up of solids within the nozzle as well as to prevent galling from occurring when the nozzle includes a threaded section.

### BACKGROUND OF THE INVENTION

1. Field of the Invention

The present invention relates, in general, to spray nozzles and in particular to a new and useful spray nozzle having a plating impregnated with a lubricious material for the prevention of galling, wear and corrosion, and methods of forming such a spray nozzle.

2. Description of the Related Art

Spray nozzles are used in various industries to apply liquids, powdered solids or gasses.

Liquids are often used to clean another surface and may include the application of chemicals. Regardless of the media being applied there is a constant problem of abrasion on and the adherence of solids to the nozzle surfaces. Additionally, it is possible that liquids or gasses could actually solidify on the nozzle. These occurrences have detrimental effect on the performance of the nozzle. Accordingly, there is a need for a nozzle that is resistant to abrasion and wear from chemicals and prevents the adherence of solids on the nozzle surfaces.

Current spray nozzles also suffer from issues regarding their ability to be changed when they are worn out, corroded, or simply dirty. Typically spray nozzles are formed of austenitic stainless steels. These steels provide for superior corrosion and abrasion resistance compared to other materials. However, when the nozzles are assembled into fittings of similar material, galling can occur between the mating surfaces. Galling is defined in MCGRAW-HILL DICTIONARY OF SCIENTIFIC AND TECHNICAL TERMS, 5^{th} ed. as surface damage on mating, moving metal parts due to friction caused by local welding of high spots. When galling occurs, the threads become unusable. This not only damages the nozzle that may be easily replaced, but also damages the machinery into which the nozzle is threaded. Such damage may limit the functionality of that machinery, require costly repairs, or render that piece of equipment unusable. Accordingly, there is a need for a nozzle that will resist damage and clogging along with the effects of galling and enable a mechanic to easily replace a worn or dirty nozzle without threat of damaging the equipment.

### SUMMARY OF THE INVENTION

The present invention relates to a spray nozzle comprising, a housing, an inlet orifice, an outlet orifice, a lumen connecting the inlet and outlet orifices, and a lubricious plating. The lubricious plating may include nickel, titanium nitride, titanium carbonitride, titanium aluminum nitride, chromium nitride, zirconium nitride, black oxide and modified tungsten disulfide and other metal and non-metal materials. The lubricious plating is preferably impregnated with PTFE or other lubricating material. The housing may be formed of stainless steel and have threads which may also be coated with the lubricious plating.

The present invention also relates to a method of preventing galling and corrosion in a spray nozzle. The steps include providing a spray nozzle and plating the spray nozzle. Preferably the plating is impregnated with a lubricating material. The lubricating material may be PTFE. The plating may include nickel, titanium nitride, titanium carbonitride, titanium aluminum nitride, chromium nitride, zirconium nitride, black oxide and modified tungsten disulfide and other metal and non-metal materials.

The various features of novelty which characterize the invention are pointed out in particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 depicts a front perspective view of a nozzle.

FIG. 2 depicts a bottom view of a nozzle.

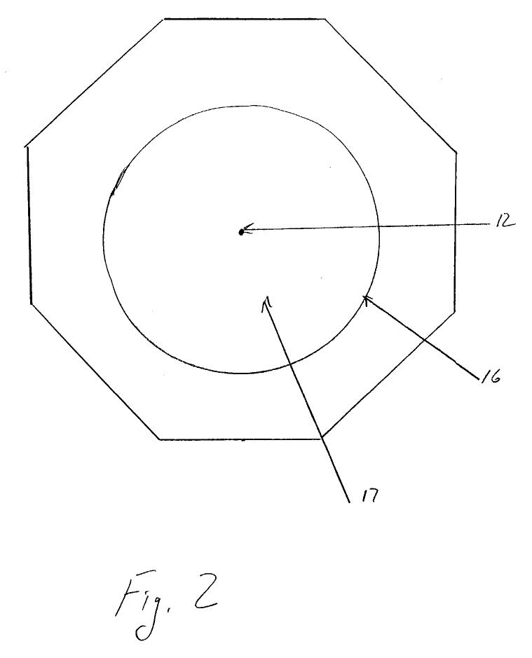

FIG. 3 depicts a cross sectional view of the nozzle, cut along line 3-3.

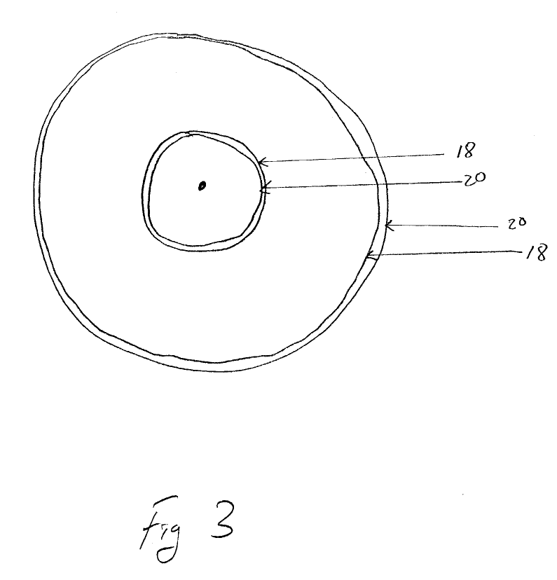

### DESCRIPTION OF THE PREFERRED EMBODIMENTS

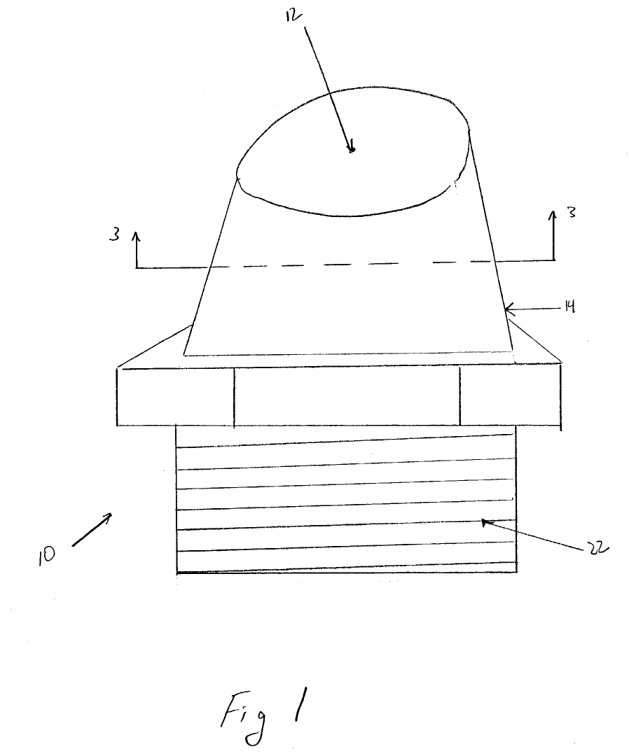

Referring now to the figures, a spray nozzle 10 is provided including a body 14, an inlet orifice 16, an outlet orifice 12, and a lumen 17 connecting the inlet and outlet orifices. The entire spray nozzle 10 is plated with a plating material 20. It is preferable that the nozzle 10 includes threads 22, as shown in FIG. 1. Further, it is preferable that the nozzle 10 is formed of a stainless steel, although other materials may be used without departing from the scope of this invention.

The nozzle 10 is preferably attached via the threads 22 to a delivery device (not shown) which supplies a material to be sprayed by the nozzle 10. The material enters the inlet orifice 16, passes through the lumen 17, and exits the outlet orifice 12. The materials that are passed through the nozzle may include liquids, solids, slurries, and gasses.

Because these materials often contain chemicals that are corrosives, or the materials themselves may be abrasive and cause erosion, the nozzle is preferably coated or plated with a material such as nickel. Other materials which may be used include but are not limited to titanium nitride, titanium carbonitride, titanium aluminum nitride, chromium nitride, zirconium nitride, black oxide, modified tungsten disulfide and other metal and non-metal materials.

Additionally, the plating is impregnated with a lubricious material. One example of a lubricious material is Polytetrafluoroethylene (PTFE). Other materials may be substituted for PTFE without departing from the scope of this invention. The impregnation of the lubricious material into the plating metal acts to prevent many of the corrosive and abrasive effects of forcing a material through a nozzle 10.

The plating with the impregnated lubricious material of the lumen 17, the inlet orifice 16, and the outlet orifice 12 works to eliminate much of the corrosive and abrasive effects of the materials which pass there through. Additionally, the PTFE impregnation of the plating works to prevent the build up of solids on the interior surfaces of the lumen 17. Often these solid deposits form and can act to plug the nozzle 10 by plugging orifice 12. Further, these deposits can lead to localized pitting due to the corrosive nature of the solid or localized erosion within the nozzle. The pitting could further result in damage to the threads of the delivery device.

The plating with the impregnated lubricious material of the threads 22 of the nozzle 10 has the beneficial effect of limiting galling of the threads. As described above, galling results in the destruction of the threads and local welding. While this may or may not effect the life of the individual nozzle, the effects of galling on the delivery device can be catastrophic, resulting in down time or possible scrapping of the entire device. Galling is typically prevented by the isolation of similar metals by a dissimilar metal. Accordingly, the plating of the threads with nickel or other material as described herein prevents galling. Further, the lubricious nature of a material such as PTFE allows for smoother and easier insertion and removal of the nozzle 10 from the delivery device.

While the invention has been described in connection with what is considered to be the most practical and preferred embodiment, it should be understood that this invention is not limited to the disclosed embodiments, but on the contrary, is intended to cover various modifications and equivalent arrangements included within the spirit and scope of the appended claims.

What is claimed is:

1. A method of preventing galling and corrosion in a spray nozzle comprising the steps of:
providing a spray nozzle; and
plating the spray nozzle with a material, wherein the material is impregnated with a lubricating material.

2. The method as recited in claim 1, wherein the material is nickel.

3. The method as recited in claim 1, wherein the lubricating material is PTFE.

4. The method as recited in claim 1, wherein the material is one selected from the group consisting of titanium nitride, titanium carbonitride, titanium aluminum nitride, chromium nitride, zirconium nitride, black oxide and modified tungsten disulfide.

5. The method as recited in claim 1, wherein the spray nozzle is formed of a stainless steel.

6. The method as recited in claim 1, wherein the spray nozzle comprises a threaded portion.

7. The method as recited in claim 1, wherein the spray nozzle is a liquid spray nozzle.

8. A spray nozzle comprising:
a housing;
an inlet orifice;
an outlet orifice;
a lumen connecting the inlet and outlet orifices; and
a lubricious plating.

9. The spray nozzle of claim 8, wherein the lubricious plating is formed of a material having wear resistance, anti-galling, and anti-adhesion properties.

10. The spray nozzle of claim 8, wherein the lubricious plating is formed of nickel.

11. The spray nozzle of claim 10, wherein the lubricious plating is impregnated with PTFE.

12. The spray nozzle of claim 8, wherein the lubricious plating is selected from the group consisting of titanium nitride, titanium carbonitride, titanium aluminum nitride, chromium nitride, zirconium nitride, black oxide and modified tungsten disulfide.

13. The spray nozzle of claim 12, wherein the lubricious plating is impregnated with PTFE.

14. The spray nozzle of claim 8, wherein the housing is formed of a stainless steel.

15. The spray nozzle of claim 8, wherein the housing includes a portion having threads thereon.

16. The spray nozzle of claim 15, wherein the threads are plated with the lubricious coating.

17. An improved spray nozzle of the type having a housing, an inlet orifice, an outlet orifice, a lumen connecting the inlet and outlet orifices, wherein the improvement comprises a lubricious plating.

18. The spray nozzle of claim 17, wherein the lubricious plating is formed of a material having wear resistance, anti-galling, and anti-adhesion properties.

19. The spray nozzle of claim 17, wherein the lubricious plating is formed of nickel.

20. The spray nozzle of claim 19, wherein the lubricious plating is impregnated with PTFE.

21. The spray nozzle of claim 17, wherein the lubricious plating is selected from the group consisting of titanium nitride, titanium carbonitride, titanium aluminum nitride, chromium nitride, zirconium nitride, black oxide and modified tungsten disulfide.

22. The spray nozzle of claim 21, wherein the lubricious plating is impregnated with PTFE.

23. The spray nozzle of claim 17, wherein the housing is formed of a stainless steel.

24. The spray nozzle of claim 17, wherein the housing includes a portion having threads thereon.

25. The spray nozzle of claim 24, wherein the threads are plated with the lubricious coating.
